(19) United States
(12) Patent Application Publication
(10) Pub. No.: US 2008/0034981 A1
(43) Pub. Date: Feb. 14, 2008

(54) Combination whisk / spatula

(76) Inventor: G. Philip Mayer, (US)

Correspondence Address: G. Philip Mayer Jr., P.O. Box 1406, Friday Harbor, WA, 98250, US

(21) Appl. No.: 11/502,123

(22) Filed: Aug. 11, 2006

(51) Int. Cl. A47J 37/10

(52) U.S. Cl. 99/424

(57) ABSTRACT

A cooking utensil combining the capabilities of both a whisk and a spatula is arranged with a plurality of resilient wire loops protruding outwardly from a handle forming a cage wherein at least one of the wire loops is provided for with a heat resistant flexible wiper arranged for making contact with and wiping the internal surfaces of a mixing container.

### BACKGROUND OF THE INVENTION

This invention relates in general to kitchen cooking utensils used for mixing and beating such cooking ingredients as sauces creams oils eggs etc. in the preparation of foods. And more directly to the combining of two different utensils that are normally used in conjunction with each other, the whisk, a common utensil used for mixing and stirring ingredients in a container, and a Spatula (also a common kitchen utensil) which provides the “wiping” action required for removing the stirred ingredients from a mixing container.

The whisk is a well known and common cooking tool usually comprised of a number of loops of wire extending from a griping handle. The utensil is used to beat, stir or mix up ingredients that require blending. Although the traditional wire cage type design of the whisk has proven ideal for the purpose of mixing or blending ingredients in a sauce pan or similar container. When the mixed or blended ingredients are poured or transferred from the mixing vessel or sauce pan, a different utensil such as a Spatula is usually required. The Spatula is also a common food preparing instrument usually comprised of a rubber or elastic material formed in a paddle like shape and bonded to a gripping handle. The spatula allows the user to wipe all of the pre mixed ingredients as prepared with the whisk, out of the vessel or container wherein it was mixed; into another container as might be required by the cook or chef. The paddle shaped end of the Spatula is usually arranged with a decreasing thickness in cross section providing for an extremely flexible lip along the bottom and at least one side of the paddle like shape. This flexible lip aids in the Spatula's ability to conform to the interior geometry or shape of a mixing vessel or container, thus allowing the user to wipe the interior of the vessel clean when transferring the mixed ingredients from one container to another and reducing waste of any of the prepared or pre mixed ingredients.

Presently, the operation as described herein requires the need for two separate utensils, one for mixing the ingredients, and one for wiping or transferring the mixed ingredients into another vessel. This need for two separate utensils contributes to not only considerable loss of time for the cook, but an increased number of utensils to manipulate and clean.

Accordingly, It is an object of the present invention to disclose a combination utensil that combines the attributes of the whisk and the Spatula into one kitchen utensil wherein the mixing, beating and stirring of an ingredient can be preformed, as well as the clean and efficient transferring of all the ingredients from one vessel or container to another without changing utensils or dirtying additional utensils.

### SUMMARY OF THE INVENTION

In accordance with the present invention, a combination whisk/spatula kitchen utensil is disclosed. The combination utensil comprises a griping handle for holding the utensil wherein a plurality of resilient wire loops extend axially from the handle. Wire loops are oriented to generally form a pear shaped cage. An outer most wire loop is provided for with a heat proof highly resilient rubber or composition material forming a wiper, This aforementioned wiper is vulcanized or otherwise bonded to the outer most wire loop wherein the combination of the paddle shaped geometry of the wiper component and the resilient nature of the material from which it is formed allows the wiper to conform to and wipe clean irregular shaped surfaces of a plurality of configurations of containers.

It is an object of this invention to provide a kitchen utensil that combines two of the most common and necessary kitchen tools, the Whisk and the Spatula, into one inexpensive easy to use utensil thus simplifying mixing or stirring of ingredients as well as the disbursement of the prepared mixture. It is a further objective of this invention to reduce the number of utensils required to be cleaned or otherwise maintained or handled in the process of preparing food.

Further definition of the preferred embodiment including details of the invention and it's advantages will be apparent from the detailed description and drawings included below wherein,

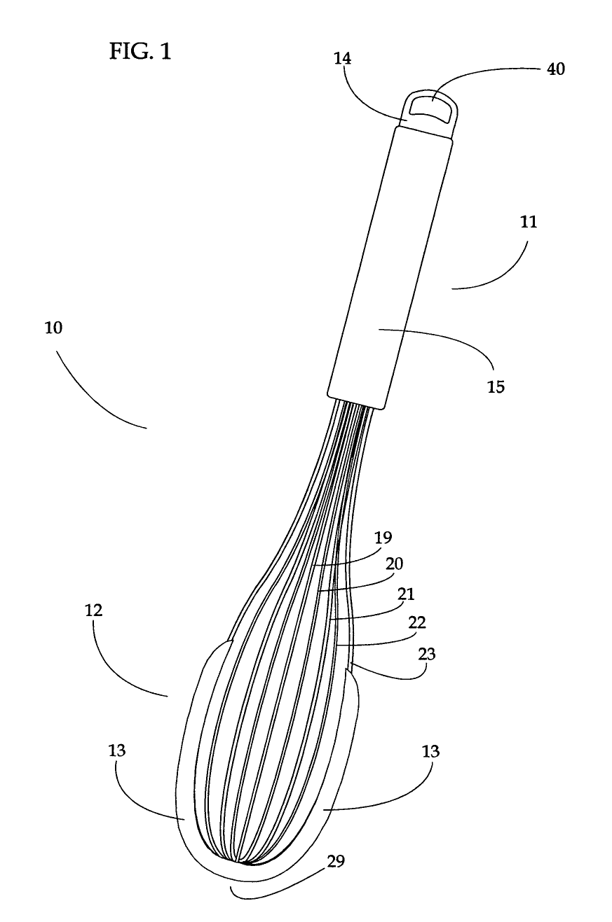

FIG. 1 shows the whisk/spatula utensils general configuration and component parts.

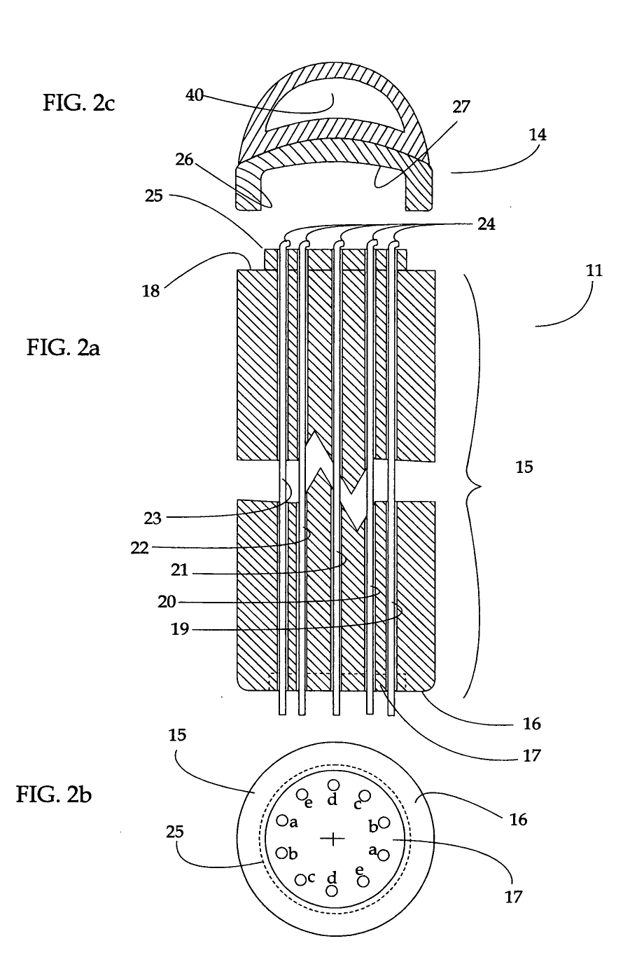

FIG. 2a shows cut away details of the handle body.

FIG. 2b shows hole pattern detail of whisk/spatula handle wherein radial spacing is Maintained between resilient wires.

FIG. 2c shows cap detail of whisk/spatula

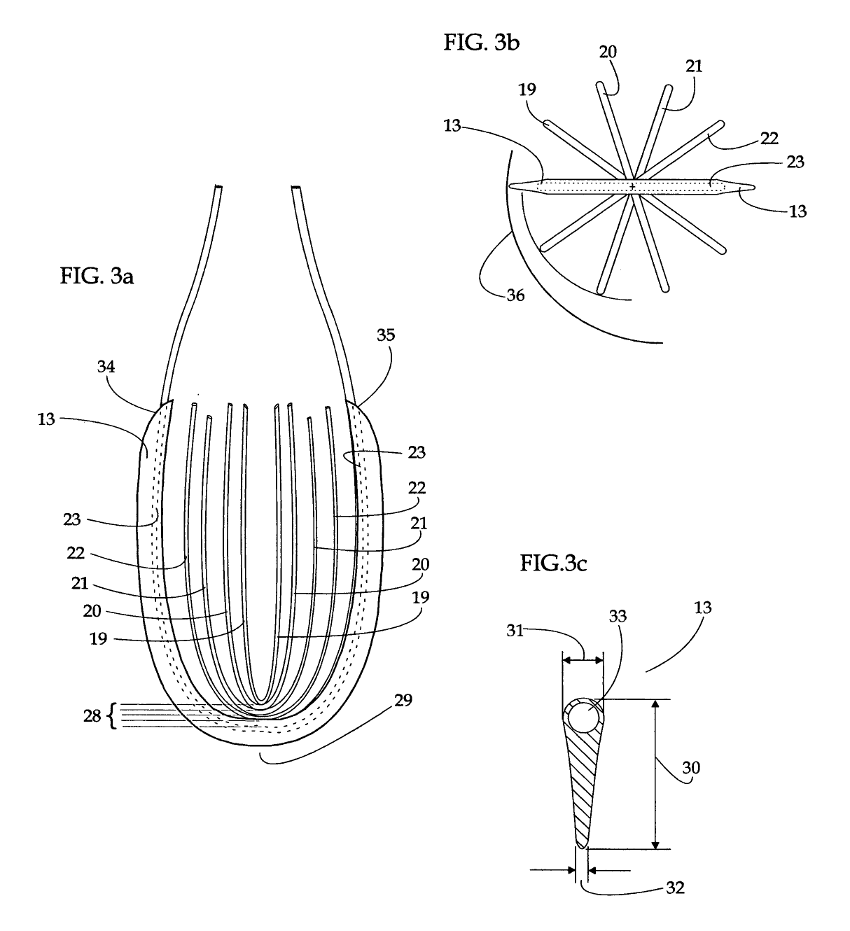

FIG. 3a shows flexible wiper, partial view of cage and resilient wire clearance details.

FIG. 3b shows end view of radial orientation and cage diameter difference between Resilient wires and flexible wiper.

FIG. 3c shows enlarged cross section view of flexible heat resistant wiper detail

### DETAILED DESCRIPTION

Referring now to FIG. 1 wherein the whisk/spatula of the present invention will herein be referred to as the utensil and be referenced by the numeral 10. Basic component parts of utensil 10 are comprised of a metallic or plastic composite handle 11, for the purpose of griping utensil 10. A plurality of resilient stainless steel wires 19,20,21,22, and 23, approximately 0.075″ in diameter provide for both the spatula and whisk component of utensil 10 by forming an approximate pear shaped cage 12. A spatula component herein referred to as wiper 13 is part of cage 12, and a Cap 14 provided on top of handle 11.

Referencing FIGS. 2a, 2b, and 2c wherein FIG. 2a shows a shortened cutaway view of body 15 of handle 11, FIG. 2b shows the radial pattern of holes in base 16 of body 15 arranged for orienting resilient wires 19,20,21,22 and 23 which form cage 12, and sealing recess 19 in base 17 of handle 11, and, FIG. 2c shows plan view of cap 14 of handle 11.

Referencing again FIG. 2a wherein handle 11 comprises an elongated cylindrical form approximately 4″ in length and 1″ in diameter and further described as having body 15, a base 16 located on the bottom end of body 15 is provided for with a recessed sealant cavity 17, and a top 18 opposite base 16 on the upper end of body 15 of handle 11. Top 18 of body 15 is arranged for mating with cap 14. Both cap 14 and body 15 of handle 11 to be molded or otherwise formed from a metallic or plastic composition material, which would be compatible with a standard bonding agent and with each other.

Referencing now FIG. 2b wherein a pattern of diametrically opposed holes labeled aa., bb, cc, dd, and ee are provided in base 16, of body 15. Holes aa, bb, cc, dd and ee continue through body 15 as shown in FIG. 2a, and exit at top 18 of body 15 in handle 11. Diametrically opposed hole pattern is provided to accommodate the plurality of resilient wires 19,20,21,22, and 23 which form pear shaped cage 12. Holes aa, bb, cc, dd and ee, being diametrically opposed allow resilient wires 19, 20,21,22, and 23 to maintain a radial geometric relationship with each other to form pear shaped cage 12.

Continuing to reference FIG. 2a, Wherein top 18 of body 15 section of handle 11 is provided for with an integrally molded in shoulder 25. Shoulder 25 is provided for the purpose of properly locating and providing a bonding surface for cap 14.

Referencing FIG. 2c wherein Inside wall 26 of cap 14 is arranged to fit over shoulder 25 at top 14 of body 15 during assembly of handle 11 of utensil 10. Cap 14 is to be substantially bonded to shoulder 25 of body 15 on handle 11 for the purpose of limiting axial movement of resilient wires 19,20,21,22, and 23 between inner crown 27 of cap 14 and top 18 of handle 11 body 15 of utensil 10. Cap 14 of handle 11 to be provided with opening 40 for the purpose of hanging utensil 10 on a hook when not in use. Referencing again FIG. 2a

Wherein the approximate pear shape of cage 12 is formed by the manner in which resilient wires 19,20,21,22, and 23 of utensil 10 bend in a natural fair curve generated by the means in which they are contained in body 15 of handle 11, wherein each of the two terminal ends 24 of resilient wire 19 are passed into the diametrically opposed pairs of holes aa, located at base 16 in body 15 of handle 11 and wherein each of the two terminal ends 24 of resilient wire 20 will be threaded into opposed pair of holes as indicated by bb in base 16 of body 15 of handle 11.

and each of the terminal ends 24 of resilient wire 21 will be threaded into opposing holes cc in base 16 of body 15 of handle 11. Continuing on, each of the terminal ends 24 of resilient wire 22 will be threaded into opposing holes dd in base 16 of body 15 of handle 11, And finally, each of the terminal ends 24 of resilient wire 23 will be threaded into opposing holes ee in base 16 of body 15 of handle 11. Each of the five sets of terminal ends 24 will enter handle 11 through base 16, continue through body 15 of handle 11 and exit through top 18 of body 15 of handle 11.

Each of the pairs of terminal ends 24 of resilient wires 19,20,21,22, and 23 are then bent over or otherwise deformed as shown in FIG. 2a insuring that resilient wires 19,20,21, 22 and 23 will not slip back through their respective holes aa, bb, cc, dd and ee in top 18 of body 15 in handle 11 upon completion of assembly of utensil 10.

Continuing to reference FIG. 2a wherein cavity 17 in base 16 of body 15 in handle 11 is provided for application of an optional sealing compound, wherein sealing compound would be applied as a final assembly operation for the purpose of insuring that foreign or food partials would not contaminate the areas where resilient wires 19,20,21,22 and 23 enter base 16 of body 15 in handle 11.

Referring now to FIG. 3a showing a partial view of pear shaped cage 12. For the purpose of establishing clearance 28 between resilient wires 19,20,21,22 and 23 where they converge at tip 29 of cage 12, each individual resilient wire forming cage 12 starting with resilient wire 19, and including each of the following resilient wires, 20,21,22, and 23, are to be increased in total length from the previous wire approximately 0.200″. This slight difference in length will provide for a non-interfering clearance between resilient wires 10,20,21,22 and 23 at tip 29 of utensil 10.

Resilient wire 23 will have the greatest length as resilient wire 23 is the wire that wiper 13 is bonded to; allowing wiper 13 of resilient wire 23 to extend outside resilient wires 19,20,21, and 22 insuring that there will be no interference between resilient wires 19, 20, 21, and 22 and wiper 13 insuring wiper 13 clear and unobstructed access to internal sides of cooking vessel 36 as shown in FIG. 3b

Referencing now FIG. 3c showing wiper 13 cross section. Wiper 13 to be molded or otherwise formed of a resilient heat resistant rubber composition. Width 30 of wiper 13 to be approximately 0.500″ with thickness at major cross section 31 to be approximately 0.150″. Major cross section 31 to taper to approximately 0.035″ at end 32 of wiper 13. Wiper 13 cross sectional geometry to provide for a hole 33 to continue axially through length of wiper 13 and centered approximately within major cross section 30. Hole 33 provides clearance for resilient wire 23 to be inserted substantially through wiper 13 wherein wiper 13 is vulcanized or otherwise permanently bonded to resilient wire 23. Referencing FIG. 3a again wherein wiper 13 material to be bonded to resilient wire 23 wherein wiper 13 will extend approximately from point 34, down resilient wire 23 around tip 29 of pear shaped cage 12 and continuing upward to approximately point 35 on resilient wire 23. Points 34 and 35 will normally fall slightly above the midpoint between tip 29 of pear shaped cage 12 and base 16 of handle 11.

It is the inventors opinion that the preceding detailed description of the preferred embodiment of the WHISK/SPATULA satisfies the afore mentioned objectives Of combining two important and necessary kitchen tools into one useful and efficient utensil.

Although preferred embodiments of the invention have been described in the foregoing detailed description and illustrated in the accompanying drawings, It should be understood that the invention is not to be limited to the embodiments disclosed, but is capable of numerous arrangements, modifications and substitutions of parts and elements without departing from the basic spirit of the invention Accordingly, the present invention is intended to encompass such rearrangements, modifications and substitutions as parts and elements as fall within the spirit and scope of the appended claims.

What I claim is:

1. A food preparation utensil combining the physical properties of a whisk and a spatula wherein said utensil comprises a plurality of resilient wire components substantially fixed to and extending from an elongated cylindrical griping portion and wherein opposite ends of said resilient wire components are fixed within said cylindrical griping portion and wherein said geometry of said cylindrical griping portion provides means to for said resilient wire components to bend forming a general pear shape wherein each of said resilient wire components maintain equal spacing relative to each other within a radial plane and wherein at least one of said resilient wire components is provided with means to wipe residue from a flat or radiused surface.

2. A food preparation utensil outlined in claim 1 wherein said spatula component of said utensil is comprised of flexible heat resistant material.

3. A food preparation utensil set forth in claim 2 wherein said flexible heat resistant material is permanently bonded to at least one said resilient wire component.

4. A food preparation utensil as outlined in claim 3 wherein said flexible heat resistant material covers at least 40% of the exposed length of said resilient wire component.

5. A food preparation utensil as set forth in claim 4 wherein movement of said opposite ends of said resilient wire components is restricted within said elongated cylindrical griping portion by deformation of said opposite ends of said resilient wire components and a movement restricting cap component fixed to end of said elongated cylindrical griping portion.

6. A food preparation utensil as outlined in claim 5 wherein means of maintaining equal spacing of resilient wire components on a radial plane within said griping component is provided for by a pattern of equally spaced holes which pass through length of said elongated griping component.

7. A dual function kitchen utensil combining a flexible spatula shaped wiping member and a plurality of resilient wires arranged to form a pear shaped cage for mixing and stirring wherein both said plurality of resilient wires forming said pear shaped cage and said spatula shaped wiping member extend outwardly from a common griping handle.

8. The dual function kitchen utensil set forth in claim 7 wherein said handle provides means to radially orient and equally space said plurality of resilient wires within said said handle.

9. A dual function kitchen utensil as set forth in claim 8 wherein said spatula shaped wiping member is intrigal to at least one of the said plurality of resilient wires.

10. A dual function kitchen utensil as set forth in claim 9 wherein said plurality of resilient wires are fixed to said handle through means of deforming ends of said resilient wires and a motion limiting end cap bonded to said handle.

11. The dual function kitchen utensil set forth in claim 10 wherein a means for sealing the points at which said resilient wires enter said handle is provided.
